(19) United States
(12) Patent Application Publication
(10) Pub. No.: US 2024/0426691 A1
(43) Pub. Date: Dec. 26, 2024

(54) AUTOMATED GAS DETECTION TECHNIQUES

(71) Applicant: Schlumberger Technology Corporation, Sugar Land, TX (US)

(72) Inventors: Lukasz Zielinski, Cambridge, MA (US); Aseev Anatoly, Menlo Park, CA (US); Christopher Boucher, Cambridge, MA (US); Manasi Doshi, Cambridge, MA (US); Raphael Gadot, Houston, TX (US); Michael Hayes Kenison, Houston, TX (US); Carsten Falck Russenes, Sandsli (NO); Francisco Jose Gomez, Abingdon (GB); Andrew J. Speck, Cambridge, MA (US); Scott Quinn, Leeds (GB)

(21) Appl. No.: 18/752,020

(22) Filed: Jun. 24, 2024

(30) Foreign Application Priority Data
Jun. 23, 2023 (NO) 20230720

(51) Int. Cl. G01M 3/04; G01S 7/481; G01S 17/89

(52) U.S. Cl. CPC G01M 3/04; G01S 7/4814; G01S 7/4816; G01S 17/89

(57) ABSTRACT

Systems and methods are described for an automatic and adaptive scanning method to efficiently scan for gas plumes using an imaging or LiDAR based gas monitoring system. In an example, the gas monitoring system can be coupled to a laser absorption spectroscopy with LiDAR. In an example, systems and methods for optimizing the utilization of the imaging or LiDAR based gas monitoring system includes planning, commissioning, acquiring data automatically, interpreting the data, or extracting gas emission events from the data, or a combination thereof, to provide a complete lifecycle of a gas leak and a comprehensive understanding of the gas emissions. In another example, systems and methods for detecting the presence of a plume of gas includes using supervised machine learning to train a model to recognize which images contain plumes of gas and estimate corresponding rates of gas leakage based on the images.

### CROSS-REFERENCE TO RELATED APPLICATIONS

The present application claims priority to Norwegian application No. 20230720, filed Jun. 23, 2023, the entirety of which is incorporated by reference.

### BACKGROUND

Calculating the emission rate of fugitive gases is an important part of detecting and determining the extent of leaks resulting from mining activity. These fugitive gas emissions contribute to greenhouse gas emissions that are harmful to the environment. Many fugitive emissions are the result of loss of well integrity through poorly sealed well casings due to geochemically unstable cement. This allows gas to escape through the well itself (known as surface casing vent flow) or via lateral migration along adjacent geological formations (known as gas migration).

Gas imagers scan a finite field of view (“FOV”) at a time. Some solutions include scanning patterns continuously and cyclically iterating through these predefined frames, acquiring images, and marking the images as positive if it sees an identifiable plume within the frame, or negative if it does not. Each acquisition acts as a standalone observation. In solutions with recentering and zooming capabilities, upon plume detection, the imager may recenter on an estimated plume origin and acquire an additional frame at a predefined zoom (same as or different from the original zoom level). Even with optimally selected frames, such a scan cycle is prone to false positives from noise as well as large plumes spread across multiple frames, restricts attribution to sources within these predetermined frames, increases the likelihood of attributing an emission to an incorrect source, reduces the accuracy with which the duration of a leak can be calculated, limits leak rate quantification accuracy, and is susceptible to false negatives if the imager sees a portion of the plume but does not see an identifiable plume origin.

With rising concerns around gas emissions (especially greenhouse gases such as methane and carbon dioxide), it is crucial to accurately detect gas emissions along with their source, duration, and emission rate. As a result, a need exists for a gas imaging system that can adapt to real-time detections and changes.

### SUMMARY

Examples described herein include systems and methods for an automatic and adaptive scanning method to efficiently scan for gas plumes using an imaging or LiDAR based gas monitoring system. In an example, the gas monitoring system can be coupled to a laser absorption spectroscopy with LiDAR.

In an example, systems and methods for optimizing the utilization of the imaging or LiDAR based gas monitoring system includes planning, commissioning, acquiring data automatically, interpreting the data, or extracting gas emission events from the data, or a combination thereof, to provide a complete lifecycle of a gas leak and a comprehensive understanding of the gas emissions. In another example, systems and methods for detecting the presence of a plume of gas includes using supervised machine learning to train a model to recognize which images contain plumes of gas and estimate corresponding rates of gas leakage based on the images.

Both the foregoing general description and the following detailed description are exemplary and explanatory only and are not restrictive of the examples, as claimed.

### BRIEF DESCRIPTION OF THE DRAWINGS

FIG. 1 is an illustration of an exemplary system of an imaging or LiDAR based gas monitoring system, in accordance with various embodiments.

FIG. 2 illustrates a workflow for optimizing the utilization of the imaging or LiDAR based gas monitoring system of FIG. 1, in accordance with various embodiments;

FIG. 3 is an illustration of a laser spectroscopy imager, in accordance with various embodiments;

FIG. 4 illustrates raw data from a spectroscopy methane imager, in accordance with various embodiments;

FIG. 5 illustrates exemplary grey scale methane density images for a plume and for ambient methane concentration, in accordance with various embodiments;

FIG. 6 illustrates an example of an overlay format in which methane density is shown, in accordance with various embodiments;

FIG. 7 illustrates an example of an image label with methane plume and plume origin marked, in accordance with various embodiments;

FIG. 8 illustrates exemplary mask implementations, in accordance with various embodiments; and

FIG. 9 illustrates an exemplary dashboard associated with a gas leak, in accordance with various embodiments.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for an automatic and adaptive scanning method to efficiently scan for gas plumes using an imaging or LiDAR based gas monitoring system. In an example, the gas monitoring system can be coupled to a laser absorption spectroscopy with LiDAR. In an example, systems and methods for optimizing the utilization of the imaging or LiDAR based gas monitoring system includes planning, commissioning, acquiring data automatically, interpreting the data, or extracting gas emission events from the data, or a combination thereof, to provide a complete lifecycle of a gas leak and a comprehensive understanding of the gas emissions. In another example, systems and methods for detecting the presence of a plume of gas includes using supervised machine learning to train a model to recognize which images contain plumes of gas and estimate corresponding rates of gas leakage based on the images.

### Optimizing the Utilization of the Gas Monitoring System

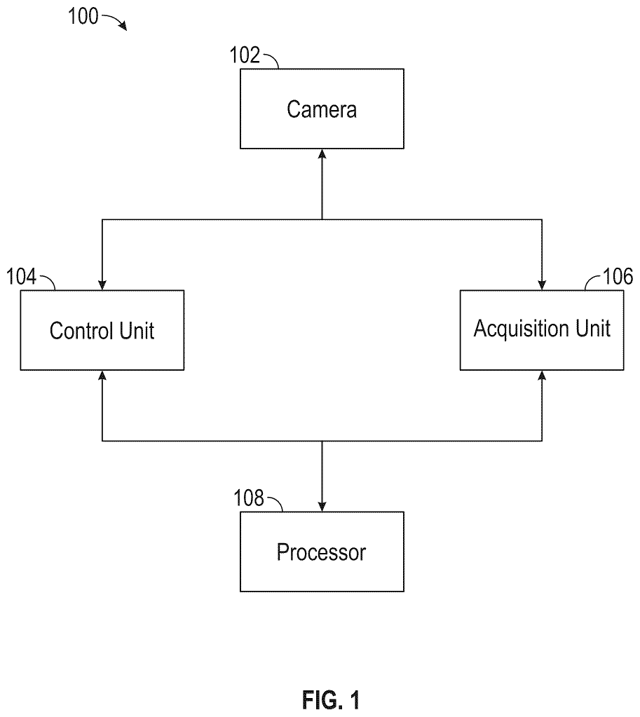

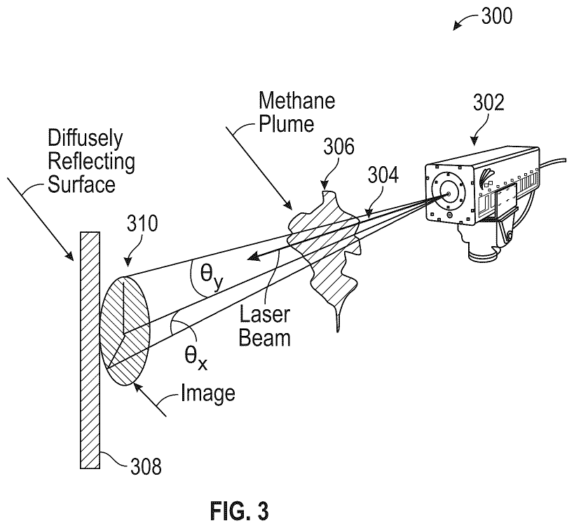

FIG. 1 is an illustration of an exemplary system of an imaging or LiDAR based gas monitoring system for performing various methods as described herein. As illustrated in FIG. 1, the system 100 includes a camera 102, a control unit 104, an acquisition unit 106, and a processor 108. In some embodiments a processor 108 may be a processor based device, such as a personal computer, tablet, a cell phone, or a server. In certain embodiments, the camera 102 may be a LiDAR spectroscopic methane imager (e.g., LiDAR camera), such as that of FIG. 3 illustrated below. The LiDAR camera accomplishes quick and accurate leak detection, quantification, and localization, and has the capability to visualize methane plumes as they originate and traverse through a facility. Such visualization helps repair crews pin-point leak sources. In certain embodiments, the LiDAR camera is a fully automated, end-to-end system that detects leaks and their locations, quantifies them, provides visual images and leak rate information on a web-based platform, and notifies operators when leaks are detected.

The LiDAR camera includes sensor hardware that combines Tunable Diode Laser Absorption Spectroscopy (TDLAS) with Differential Absorption LiDAR (DiAL) to detect the methane absorption line at ˜1651 nm and uses a Single Photon Avalanche Detector to detect returning photons. The photons emitted by a laser source return to the detector after impinging on a diffusive surface. Any methane present along the laser path will absorb photons with specific wavelengths. Using TDLAS and DiAL, the LiDAR camera continuously sweeps the output wavelength near one of the characteristic wavelengths of methane (i.e., 1651 nm) providing information about methane concentration along the laser path, while LiDAR provides the distance traveled by the laser beam. The sensor combines these measurements to provide total methane gas concentration along the laser path in parts-per-million-meter (ppm-m) units. To account for environmental effects, a full spectrum is acquired at multiple wavelengths and then the wavelength of interest (˜1651 nm) is extracted. The camera is equipped with a pair of Risley prisms that scan a conical field of view by moving the laser within a cone of up to 12 degrees half cone angle (24 degrees field of view) every 10 milliseconds. The camera has a zooming feature which determines the cone angle scanned by the Risley prisms. The camera hardware is mounted on a pan-tilt stage to scan 3D space around it.

After the LiDAR camera is installed, the camera executes a scanning plan that lists the pan and tilt angles corresponding to locations with equipment that have the potential to leak methane and the zoom level best-suited to scan each equipment. A complete scan of all pieces of equipment in a single camera's line of sight may take a few hours depending on site complexity, after which the scan pattern is repeated. Creation of a frame sequence for emissions monitoring can be aided by LiDAR range measurements, reflected light intensity, and an accompanying RGB camera. For larger sites in which many pieces of equipment may block each other's view, two or more cameras may be installed at different locations.

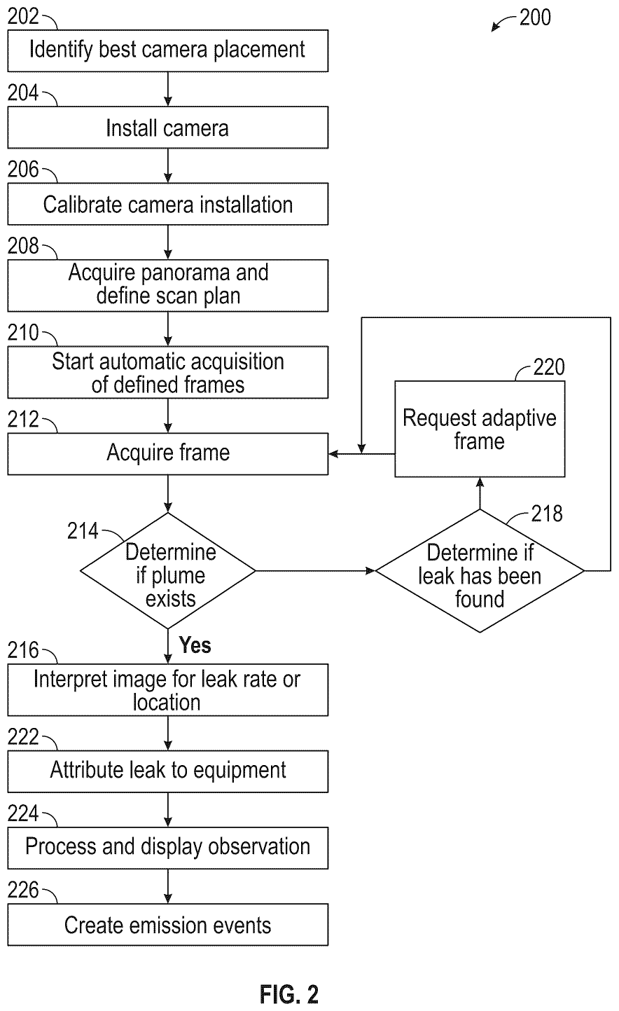

FIG. 2 illustrates a workflow 200 for optimizing the utilization of the imaging or LiDAR based gas monitoring system of FIG. 1 that includes planning, commissioning, acquiring data automatically, interpreting the data, or extracting gas emission events from the data, or a combination thereof, to provide a complete lifecycle of a gas leak and a comprehensive understanding of the gas emissions. At block 202, an operator of the imaging or LiDAR based gas monitoring system 100 may determine the best camera placement on a site. In some embodiments, equipment at the site that could potentially release gas (e.g., methane) leaks are identified and recorded as “a priori” information at or before block 202. At block 204, after the best placement for the camera 102 is determined, the operator may install the camera 102. At block 206, the camera 102 may be calibrated for various misalignments (e.g., including the position and/or tilt of the mast, the camera's orientation relative to true north, and/or issues with the pan and/or tilt stage alignment).

At block 208, a panorama scan is then acquired by the camera 102 and equipment groups located on the stitched image to determine where to automatically scan, resulting in a collection of frames. The camera 102 requires spending a few minutes at a specific location to record enough information to determine the presence of a leak. It would take many hours, if not days, to scan a complete facility without optimizing the scanning plan. A mitigation is to record a panorama during the initial deployment phase, and then select a plan to inspect only the locations that are subject to potential leaks (e.g., “a priori” information identified at or before block 202). This reduces drastically the inspection time, and, therefore, improves the time to detect a leak. The plan determined by the panorama is downloaded or otherwise transmitted to the control system (e.g., control unit 104).

After the plan is received by the control system 104, at blocks 210 and 212, the acquisition unit 106 automatically starts acquiring one or more frames based on the panorama scan. For each frame acquired, at block 214, the processor 108 determines if a plume exists in the frame of the panorama scan. If the processor 108 determines that a plume exists in the frame of the panorama scan, the processor 108 interprets the image (e.g., frame) for a leak rate and/or a location at block 216. The frames are executed with the widest zoom possible to optimize the scanning time. Accuracy of the detection and quantification can be greatly improved when using higher zooms for objects that are far along with other techniques. If the processor 108 confirms the existence of a leak and that the camera 102 is not properly aligned for best accuracy, at block 218, the processor 108 requests an adaptive frame to improve metrology at block 220.

Simultaneously, based on the “a priori” information collected at or before block 202, the processor 108 determines which equipment unit is most likely the source of the gas leak at block 222. At block 224, the processor 108 displays an observation to the operator (e.g., via a display devices) based on the equipment unit determined at block 222 and the leak rate and/or location determined at block 216. Additionally, the processor 108 may create an emission event and/or track the lifecycle of the gas leak at block 226.

The embodiments described herein significantly improve upon a discrete camera set up manually by ensuring good metrology and short time to leak detection through optimized camera placement, optimized adaptive scanning plans, and accurate metrology. Additionally, the multitude of checks for confirmation of a leak ensures no false positive events are reported. Finally, extracting emission events gives a complete picture of the lifecycle of a leak and a comprehensive understanding of the total methane emitted.

In certain embodiments, a user interface may be generated and displayed via a display device. The user interface may be a web-based data interface, or other type of suitable interface. For each measurement taken, by any of the methane measurement technologies applied, the interface evaluates if the measurement if from a new emission or from an existing emission. Using spatial queries across defined sources with uncertainty, each measurement is “binned” that is likely to belong to the same emission and tracked over time. This provides the temporal aspect of the lifecycle of the emission from start to end and can be used to calculate the best overall estimate of the actual emission rate and the most probable source, which are referred to as Emission Events. This information may also be used to classify different emission types—intermittent process emissions, or continuous fugitive emissions. Thus, the user interface aids in reducing false-positives and repeated notifications for the same emission, gives the accumulated methane emitted for each leak (within uncertainty margins) and the total methane emitted for a given area (location) over time, which is useful information for the operators.

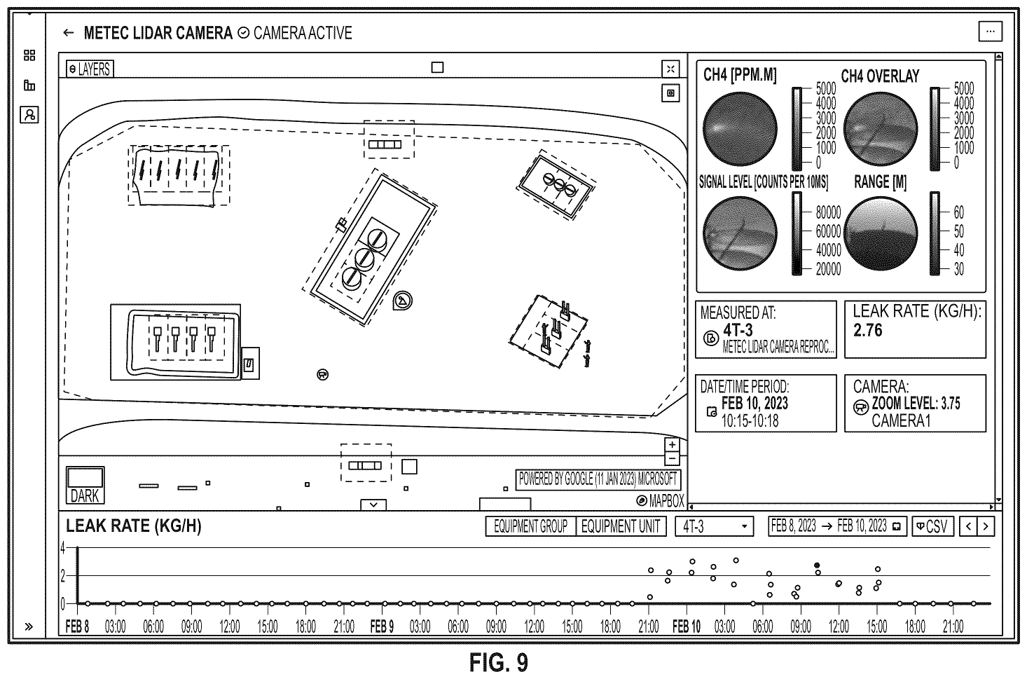

FIG. 9 illustrates an exemplary dashboard that show the leak location and its images along with the rate as a function of time. The data visualized on the dashboard is a result of the data acquired by the hardware as well as algorithms running in the cloud to estimate the position and rate of the methane leak. The operator/user can take an action for leak abatement after being notified of the emissions at their site, and issue work orders accordingly.

### Detecting a Plume of Gas Using a Model Trained Using Supervised Machine Learning.

As mentioned above, certain embodiments described herein include systems and methods for detecting the presence of a plume of gas includes using supervised machine learning to train a model to recognize which images contain plumes of gas, which images contain noise, and estimate corresponding rates of gas leakage based on the images.

FIG. 3 is an illustration 300 of a laser spectroscopy imager 302 (e.g., a LiDAR spectroscopic methane imager) that may be utilized in various embodiments as described herein. As illustrated in FIG. 3, the laser spectroscopy imager 302 may emit a laser beam 304 toward and/or through a gas (e.g., methane) plume 306 to a diffusely reflecting surface 308 behind the gas plume 306, thereby generating an image 310. Each pixel in the image 310 represent the quantitative density of the gas (e.g., methane) along the path of the laser beam 304 from the laser spectroscopy imager 302 to the reflecting surface 308 behind the gas plume 306. The image 310 may be used as “a priori” information, a panorama scan, one or more frames of the panorama scan, or a combination thereof, as described herein.

In certain embodiments, a first machine learning model may be generated based on a gas (e.g., methane) density image (e.g., image 310), underlying gas density data, and/or any other acquired data (e.g., light intensity, LiDAR range, one or more RGB images). The machine learning model may be used to detect or predict whether a methane plume is present in the frame of the image. In certain embodiments, a second machine learning model may be generated that would automatically predict the emission rate of the gas (e.g., methane), based on the gas density image and, optionally, additional data (e.g., wind speed, wind direction, other meteorological data). In certain embodiments, the first machine learning model and the second machine learning model may be generated and/or trained as the same machine learning model.

### Data Acquisition and Preprocessing of the Machine Learning Model.

The machine learning model may receive raw spectroscopy data, images generated from raw spectroscopy data, or the like, or a combination thereof, as input. For example, raw spectroscopy data may be processed to generate images of methane density, light intensity, and range. The raw spectroscopy data may be available in a variety of formats (e.g., a spreadsheet, text, a CSV file, some binary format). The images may be available in any electronic image format (e.g., png, tiff, jpeg, or bitmap).

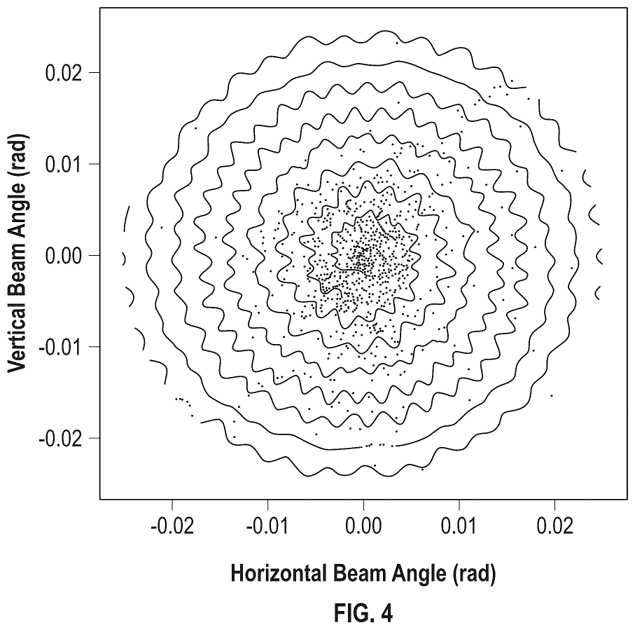

In certain embodiments, the raw spectroscopy data may be in a format where pixel coordinates are provided as horizontal and vertical beam angles (e.g., qx and qy in FIG. 3), which represent angular displacement of the laser beam direction relative to the image center; or the pixel coordinates may be the standard x and y Cartesian coordinates, or any other coordinate set; or both. Unlike for standard RGB cameras or for passive thermal camera methane imagers, the laser spectroscopy imager 302 does not contain a dense array of light sensors whose physical layout on the chip defines the pixel location and dimension and thus the image resolution. There may be only one or several very sensitive light detectors present and the image resolution and pixel coordinates are fixed by the scan pattern of the laser beam and the acquisition time required at each point to obtain sufficient signal to noise ratio. Depending on the particular hardware implementation used, the scan pattern itself may not be evenly space filling, as shown in FIG. 4. FIG. 4 illustrates the typical raw data from a spectroscopy methane imager (e.g., the laser spectroscopy imager 302).

### Image Processing and Display

One or more images may be generated based on the raw spectroscopy data. For example, the raw methane density data illustrated in FIG. 4 may be turned into an actual image suitable for the application of standard machine learning image classification and segmentation techniques. This process requires one or more steps as described herein.

The coordinate space, whether Cartesian or horizontal and vertical beam angles, must be gridded into some type of a grid. The grid could be a regular square, rectangular grid, or any type of polygonal grid. The values of the raw data must then be rendered onto this grid by some scheme typically referred to as rasterization.

There are different types of rasterization algorithms that may be use for this purpose such as Bresenham's line algorithm or Wu's algorithm among many others. Or simple binning of the data into the grid-defined bins may be performed with some type of interpolation, for example simple window averaging or some type of 2D Gaussian convolution or any other interpolation algorithm. Any algorithm can be used that can turn the raw methane density data as shown in FIG. 4 into a filled-in 2D image data. This 2D image data can be displayed as an actual image using any type of image visualization software, for example Matlab, or one of the many different graphics packages in Python or other programming language. The images may then be saved into a standard image format, such as bitmap, png, jpg, or tiff, and used in further processing by the ML routines.

An important step is selecting the right color map to display and save the 2D image data. Unlike with the standard optical camera images, where the photograph of an object captures its intrinsic colors and saturations, in the case of the methane density image, the underlying data itself does not have any intrinsic RGB information. It is represented in units of concentration times the beam path length, e.g., parts-per-million-meter (ppm-m) and the numbers representing the density can be mapped onto an arbitrary color palette. Once the palette is selected, the additional degree of freedom is the scaling applied to the concentration-distance values when mapping them onto the palette. The simplest such scaling relies on deciding what value of the color map should the maximum and minimum data values correspond to. For example, in an 8-bit grey scale image, the values of the pixels go from 0 to 255, with 0 corresponding to a completely black point and 255 to a completely white point. In order to take advantage of the full grey scale, it may be desirable to map the lowest density value to 0 and the highest to 255. This is easily implemented directly or can be accomplished using the auto-scale feature in the various image plotting utilities. The auto-scale approach has the advantage when it comes to visual detection of the plume as it maintains a similar color gradient or differential between the plume and the surrounding background. Its main disadvantage lies in the fact that it does not preserve the quantitative information about the absolute density of the methane plume. Thus, a weak plume, corresponding to a small release of the gas could appear in an image to be as bright as a massive release in another image. In order to preserve the quantitative information contained in the raw data, one should use a single absolute scale, where both the minimum and the maximum of the scale are fixed to always correspond to specific values of the methane density. In that way, any particular pixel value, say, 150, would also always represent a particular value of methane density. The mapping can be linear but can be an arbitrary single-valued function as well.

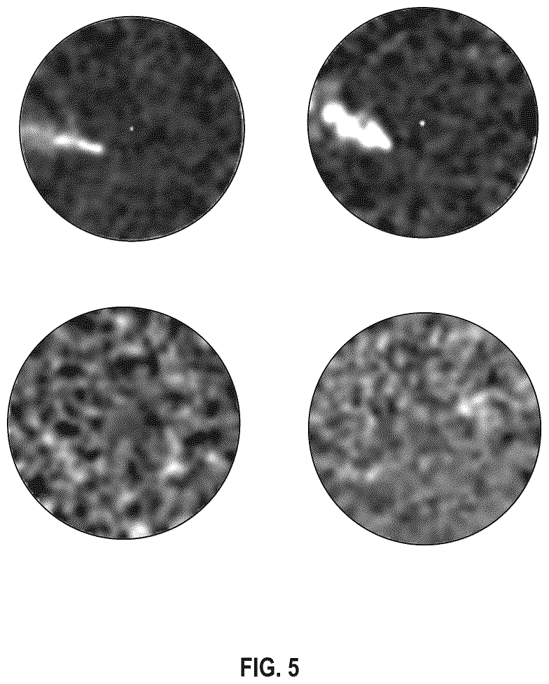

Examples of grey scale methane density images are shown in FIG. 5 both for a plume and for ambient methane concentrations. These were plotted using the auto-scale option, with the effect that the ambient background level in the bottom two images looks much brighter than the similar ambient levels in the background of the bright plumes in the top two images. The top two images of FIG. 5 contain clear bright regions that correspond to high values of methane density (e.g., methane plumes). The bottom two images of FIG. 5 do not contain such regions, and, therefore, correspond to noise, or the absence of methane plumes.

The main disadvantage of a fixed scale is that weak leaks may be difficult to discern as there will be very little absolute gradient or hue difference between the leak and the background or noise. The big leaks and high methane densities will appear bright against a dark background, while small leaks and low methane densities will appear slightly less dark against a somewhat darker background. While a clear disadvantage for a human evaluating the images, it may not be so for a machine learning algorithm. Another disadvantage is more serious as it relates to the loss of resolution if 8-bit images are used for the absolute scale. A pixel in an 8-bit image can only take on one out of 2 to the power 8 i.e. 256 distinct values while the range of potential methane densities can range by over three orders of magnitude from ˜20 ppm-m up to tens of thousands. As a result, very different methane densities, and thus plumes corresponding to very different leak rates, might end up getting lumped into an identical looking image. For example, density of 20 ppm-m and 200 ppm-m might end up mapped onto the same value of grey. This could affect the outcome of the plume detection algorithm and significantly alter the leak rate estimation and thus impact the decision-making process and prioritization of leak repairs. The solution to this problem is to use 16-bit images for the absolute scale, giving 2 to the power 16 equal 65536 distinct values to encode methane density information. This is sufficient for all practical application of the system as it can maintain the 1 ppm-m resolution far in excess of the base sensor accuracy.

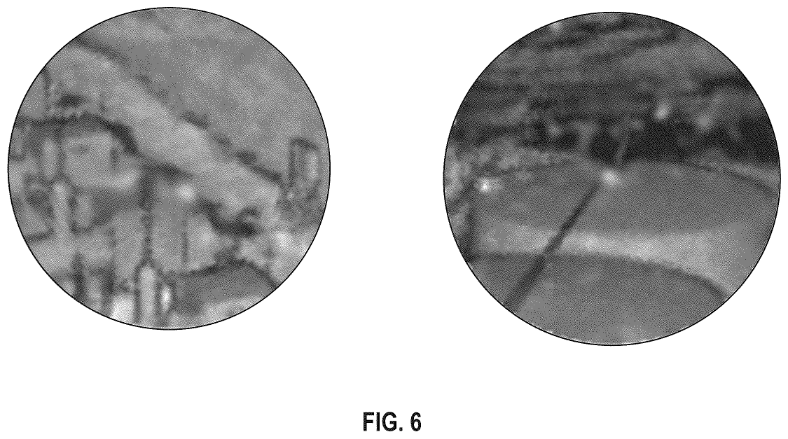

There are additional options for generating the images from the rasterized raw data. They include thresholding the data at a particular minimum and maximum value, such that all values below a certain threshold cₘᵢₙ are set equal to cₘᵢₙ and all values above a different threshold cₘₐₓ are set equal to cₘₐₓ. This approach can be used to make the plumes stand out as a uniform region in the image and to reduce the range of the noisy part of the image near and below the background methane levels. Another option is to generate an overlay image where a portion of the density image is overlaid on the photon intensity image or the LiDAR range image. The portion of the density image may be chosen such as to represent the plume if present, for example by applying a threshold above which to display the pixels. It can also be thresholded as described above. An example is shown in FIG. 6. In particular, FIG. 6 illustrates an example of an overlay format in which methane density is shown in bright orange is overlaid on top of a grey scale photon intensity image. Such an overlay display may be useful to provide the machine learning model with a way to associate the presence of the plume with equipment thereby improving the model performance.

Similar considerations apply to the other data streams generated by the camera, such as photon intensity or LiDAR range. They can be displayed in an arbitrary color palette, either grey scale or color; they can be plotted using autoscaling to improve resolution of individual frames or on an absolute scale for consistent frame-to-frame comparison. Different display modes may be preferable for specific applications.

A very different and novel way of displaying multiple data streams, e.g., methane density, photon intensity, and LiDAR range, is to combine them all into a single RGB image where each of the three channels is used as the source of for one of the three Red-Green-Blue (RGB) image channels. Thus, the intensity of red could be determined by the methane density, while the intensity of green by the photon intensity and of the blue by the LiDAR range, each mapped appropriately on the 0-255 or 0-65535 range for an 8-bit or 16-bit image. A full three-channel RGB image generated in this way in principle encodes all the information acquired by the imager and thus provides the full information for the machine learning model to train on.

Another issue that must be addressed if the image is not square is the bounding box. Typical image processing software saves an image as a square or rectangular array. Correspondingly, most readily available machine learning image algorithms expect a square or rectangular image. If the raw data for the image is not square but, for instance, circular as shown in FIGS. 5 and 6, the image will be embedded within a bounding box and saved as a square or rectangle. The bounding box will be assigned some particular RGB or grey scale value. This default value could be for example white and thus correspond to high density methane signal in the grey image, being a source of potential confusion to the model. This can be avoided by setting the bounding box to default to black, or whatever color in the color map corresponds to low methane density. Another way to address this issue is by using masks as discussed in the next section, with the bounding box assigned the value corresponding to the unusable portion of the image, causing it to be ignored by the model.

With any of these approaches, once the images are generated and saved, they can be used to generate the database required to build the ML model.

### Database Generation.

The data needs to consist of many images of methane plumes as well as null images at ambient methane concentrations that contain no plumes. Ideally, there should be thousands or tens of thousands of images or the underlying data with a good representation of both plume-containing images as well as background images. Both the plume-containing images as well as background images need to cover a wide range of situations that may be encountered in the actual application. Thus, methane plumes themselves may take on very different shapes depending on the geometry and orientation of the release point, the emission rate, the temperature and pressure of the gas, the meteorological conditions present during the emission event, the presence of buildings or other structures affecting the airflow and perhaps partially obstructing the full view of the plume. The plumes may be small or large, diffuse or focused, more or less dispersed, more spherical in shape or stretched out, rising straight up into the air or hugging the ground, filling only a small fraction of the frame or the entire frame; they can also be partially obstructed or pooled behind some structure. All of these and other conditions should ideally be represented in the dataset.

Similarly, the null or ambient-methane data and images should cover the expected range of conditions in the places where the methane imager is to be installed. As different background surfaces may have very different reflection properties or albedo, the null signal may appear quite different when reflected off grass, dirt, rock, steel, asphalt, concrete, or any other surface. The wide range of responses depending on the background reflecting surface may cause confusion when trying to decide whether a leak is present, especially for smaller leaks. To ensure robust detection, the null images from all types of surfaces that can be found at oil & gas facilities should be represented in the data set. Even the same background surface at the same site may look different to the methane imager depending on the atmospheric conditions, as the albedo may be affected by the presence of snow or ice or by moisture condensation, puddles, or by dust and debris accumulation or due to other sources of fouling or soiling. All this variability should be represented in the ambient or null data set.

While a general-purpose model can be built using a sufficiently diverse dataset of backgrounds and plume shapes, if higher prediction accuracy is required in order to detect smaller leaks and more accurately attribute them to particular equipment group or unit, a customized model for the specific site can be developed, optimized for that site. This requires acquisition of additional data at the site, both of the different background surfaces present there and potentially also of known rate methane releases against those backgrounds. This additional data would then be used to customize the model as described in the next section.

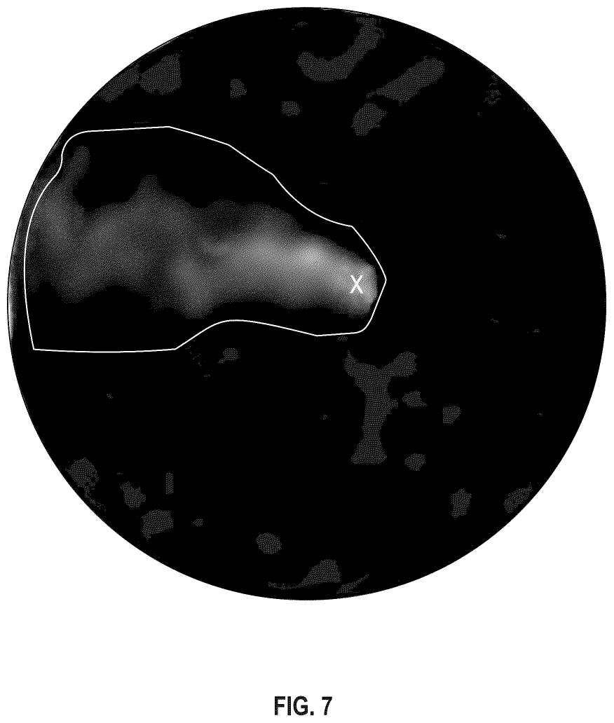

Once the underlying image data is acquired and the images generated, the next step depends on the type of machine learning model to be built. For supervised-learning models, all the images and underlying data must now be labeled. In the first modality of our invention, i.e., when the machine learning model is used only to detect the presence of the plume in the image, the label must simply be the designation of whether or not there is a plume present. For the second modality of our invention, where the machine learning model is used to predict the actual rate of emission, the additional label must include the ground truth emission rate or a selector for the range in which that emission rate falls. For instance, there could be several leak categories such as small leak e.g. leak rate <1 kg/hr; medium leak e.g. leak rate between 1 kg/hr and 10 kg/hr, and large leak e.g. between 10 kg/hr and 100 kg/hr; and superemitter, for leaks larger than 100 kg/hr. The label then would need to specify to which category the leak in the corresponding image belongs, e.g. small, medium, large, or superemitter. Any other categories or ranges could be used here as well. Additionally, for improved performance, each image could be segmented, with the methane plume marked in the density image with an outline, perhaps also marking the likely plume origin, as shown in FIG. 7. FIG. 7 illustrates an example of an image label with methane plume and plume origin marked in the image. This segmentation can be done manually by a human operator or automatically by unsupervised segmentation software, perhaps approved by a human.

For unsupervised learning, the manual labeling step is not necessary, as the algorithm itself will identify clusters of similar looking images, classifying the images containing methane plumes into a different category than those with noise only. Both supervised and unsupervised models can be trained and used for leak prediction, as described in the next section.

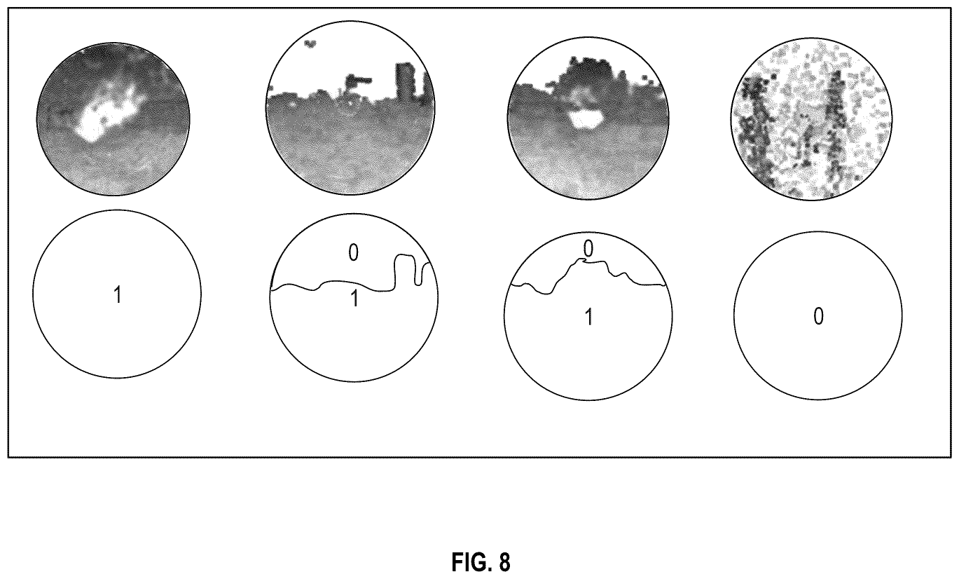

The final step in database preparation, which in some cases will further improve the prediction performance, is the generation of a mask for each image, indicating regions of the image to be used for the training vs. those that should be excluded. This mask could then be used to filter out the portions of the image with poor quality, missing, or somehow corrupted data. Some examples of the mask implementation are shown in FIG. 8. True and False or 1 and 0 or Good and Bad or any other labels could be used to indicate the usable vs unusable portions of the image; or several different categories of a continuous scale indicating the image quality could be used as well. As illustrated in FIG. 8, 1 indicates the usable portion of each image while 0 indicates the portion of each image to be excluded.

The masks can be drawn manually by inspection of the image or they can be generated automatically based on internal quality metrics of the measurement, such as for example, the returning light intensity level or photon count in each pixel; or can be generated by an automated segmentation algorithm. Only the good or usable portions of each image would be used for model training and prediction. Alternative way of implementing masking is to set the unusable portion of the image to the color corresponding to low or zero methane density, in effect signaling to the model to ignore this region. This can be done by preprocessing the image itself or by manipulating the underlying image data prior to generating the image. As mentioned before, either the masking or the setting of the portion of the image to the color corresponding to low methane density can be used to address the issue of the image bounding box.

### Data Augmentation

Machine learning models require a lot of data; the more data, the more robust the model and its prediction accuracy. For improved performance, therefore, any existing data should be augmented in a physics-respecting manner. There are a few obvious physics-based symmetries that can be implemented. One is image rotation by an arbitrary number of degrees. This will change the direction of the plume within the frame which in reality depends on the wind direction and the camera bearing and can be arbitrary. Thus, any rotated plume gives a valid possible instance of a plume image. Similarly, either horizontal or vertical reflection of the plume will yield valid plume shapes.

In the case of segmented labels with the plume-containing region clearly demarcated in the image, another physics-based augmentation is possible. It requires the knowledge of the mean background methane level C_{bkgr}. This can be obtained from the no-plume portion of the image itself or from adjacent frames with similar background and not containing methane; or from prior scans of the same frame before the methane leak appeared. That background level needs to then be subtracted from the density C within the portion of the image with marked as plume containing, yielding only the signal due to the methane emission alone. That leftover signal C−C_{bkgr} is proportional to the emission rate Q. Multiplying it by a factor Q′/Q will give the signal corresponding to a release rate of Q′. Then a new image can be synthetically generated where the portion marked as plume containing with density C is replace by density C′=(C−C_{bkgr})*Q′/Q+C_{bkgr} while the no-plume portion is kept the same. Other versions of this algorithm are possible, for instance replacing the uniform C_{bkgr} with values drawn from a noise histogram pixel by pixel. The essence is the scaling of the actual methane density with an arbitrary factor to model the effect of varying release rate.

Similarly, fully synthetic images may be generated by using the known physics of plume dispersion and fluctuations for various meteorological conditions, either via analytic formulations or via CFD (computation fluid dynamics) modeling. The resultant methane densities could then be added to the ambient methane background levels with suitable instrumental noise added in a rigorous fashion to reproduce the likely plume forms in the image. While such synthetically generated images could be used exclusively, the model would not be as representative of the real-world conditions. However, such synthetic data can be used to complement and further augment the existing real data set.

### Model Development

With the database generated as discussed in the previous section, a machine learning model can now be trained. Different models can be built with different objectives in mind. For plume detection alone, that is for determining whether there is a methane plume present in the image or not and marking the plume on the image, either supervised or unsupervised learning is suitable. Since plume detection from the sensors lies in the computer vision domain, a proven and widely used approach is to use available deep learning model architectures (or models) for computer vision, like models based on convolutional neural networks, and train a binary classifier using this model. A set of experiments utilizing the same data set but different models define which model performs better than others on the methane plume dataset. A model with the best binary classification accuracy and other important characteristics like size and performance is the final model, that can be released into production. When the new data is available, the data distribution shift may occur, and a user may notice a deteriorated model performance. In that case, the model must be revised and re-trained with additionally acquired data. The same applies to the plume segmentation or plume outline. When the data is labeled and ready for training, available instance segmentation deep learning models are tested. A model with the best accuracy metrics is used as a final plume segmentation model.

For leak rate estimation, on the other hand, supervised learning is preferred. The various modeling approaches can be combined or two or more models run in sequence. For example, one model can decide whether or not there is a plume present, while another can then delineate the plume in the image, and yet another then predict the leak rate. Each of these can be supervised or unsupervised. For example, the model to detect the plume may be supervised, based on labeled data, while the model to delineate the plume may be unsupervised auto-segmentation. Or the reverse may be the case. Or two or all of these functions can be performed by one model in a single shot.

Models can be trained on images, or alternatively, they can use any one or more data channels as inputs, and the data may be the actual sensor data used to generate the images or the images themselves saved in any of the image formats such as tiff, jpg, png, or bitmap. Thus, the models can be built based on methane density data alone, or on methane data in combination with light intensity (photon count) and/or LiDAR range and/or RGB image, whichever are available. Additional inputs complementing the imager data may also be used such as meteorological conditions, e.g., wind speed and direction, solar radiation, presence of snow, ice, or other precipitation, level of dust or pollen, temperature, etc., as well as details of the imager location and heading relative to the objects scanned (e.g., their locations, albedo, background scans, etc.). In addition to using multiple channels as inputs, the models can also be trained on merged inputs. As mentioned above in the Image processing and display section, the different inputs, for example density, intensity, and range, could all be combined into a single 3-channels array, i.e. RGB-like type format providing all the information for the training in one pseudo-image.

Using multiple inputs enables approaches that take advantage of intrinsic associations between the presence and locations of plumes and the presence and type of oilfield equipment that are particularly powerful. Thus, training various types of association-based models helps the machine learning to connect the likelihood of a given high-methane-density blob being a plume with the proximity of a piece of oilfield equipment. However, in that case, methane data is beyond the classic computer vision domain in general image-based meaning, and a model is trained from scratch where publicly available pre-trained model weights shall not be used.

Models can be trained to be more conservative or more accurate by the selection of a particular subset of the database. If avoiding false positives, or false detections of plume when there is none, is the objective, the model may be trained assuming small leaks, or leaks that are not clearly distinguishable, are actually no leaks. This will have the effect of hard-coding a higher noise threshold into the model by encouraging it to interpret all low-density features as noise rather than small plumes. This will have the additional undesirable effect of reducing detection sensitivity by allowing many smaller leaks to go undetected. Thus, if detection sensitivity is the priority a more sensitive model may be trained by assuming all low-confidence plumes, i.e., such plume-like features that may not necessarily be plumes but may in fact be noise, are actually plumes. This will ensure that no emissions are missed, however, increasing the chance of a false detection and interpreting an accidental noise spike as a methane release.

Regression-type models may be used if a continuous leak-rate prediction is desired. Or classification-type if only ranges are of interest, e.g., small-medium-large-superemitter, as discussed in the section entitled Database generation. Data must be properly labeled with a particular model in mind, however.

Models can be trained from ‘scratch’ starting with a random distribution of initial parameters (e.g. weights for neural network models); or various available pre-trained models can be used to initialize the training to achieve a more rapid convergence. Similar techniques can be applied to generate the site-specific models referred to in the section entitled Database generation. A generic plume model generated based on the global database of plumes can be used as the starting point for the additional training of based on site-specific data which will have the effect of tuning the model for that particular site and improving the prediction accuracy.

### Prediction

Once a trained machine learning model is available, it is incorporated into the data processing pipeline. As the data is acquired, it is put in the same format as the database used to train the model. Thus, if the model was trained on images, an image is generated from the data and displayed in that same colormap scheme, e.g., 8-bit or 16-bit grey scale. If the model was trained on multiple input streams, all these inputs must be available and used as input. The model is then run in the ‘predict’ mode and generates a prediction. As discussed, depending on the type of model, the prediction may be a simple plume-detection flag; or that plus a plume outline; or also a leak computation, whether continuous or an assignment to a particular leak size category.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for monitoring an emission of a gas, comprising:
receiving, from an imaging device, a gas density image;
detecting the emission of the gas in the gas density image;
determining an emission rate, an emission location, or both, of the gas based on the gas density image;
associating the emission of the gas with equipment; and
causing a user interface to be displayed on a display device, wherein the user interface comprises one or more indications of the emission rate, the emission location, or both, of the gas.

2. The method of claim 1, comprising:
determining a location of the imaging device; and
installing the imaging device at the location.

3. The method of claim 2, comprising calibrating the imaging device after the imagine device is installed at the location.

4. The method of claim 1, wherein the gas density image is a panorama of an environment.

5. The method of claim 1, comprising transmitting a scan plan to the imaging device for acquiring the gas density image.

6. The method of claim 1, wherein the imaging device automatically acquires the gas density image based on the scan plan.

7. The method of claim 1, comprising determining if a gas leak is occurring based on the gas density image.

8. The method of claim 1, comprising creating an emission event based on the emission rate, the emission location, or both, of the gas.

9. A system for monitoring an emission of a gas, comprising:
an imaging device;
a methane gas sensor;
a display device;
a memory storage including a non-transitory, computer-readable medium comprising instructions; and
a hardware-based processor that executes the instructions to carry out stages comprising:
receiving, from the imaging device, a gas density image;
detecting the emission of the gas in the gas density image;
determining an emission rate, an emission location, or both, of the gas based on the gas density image;
associating the emission of the gas with equipment; and
causing a user interface to be displayed on the display device, wherein the user interface comprises one or more indications of the emission rate, the emission location, or both, of the gas.

10. A method for detecting a plume of gas in a gas density image, comprising:
generating and training a machine learning model based on (1) raw spectroscopy data associated with the gas, one or more plumes of the gas, or both, (2) images generated based on the raw spectroscopy data associated with the gas, the one or more plumes of the gas, or both, or (3) both;
receiving a gas density image from an imaging device;
analyzing the gas density image using the machine learning model to detect a plume of gas; and
causing a display device to display an indication of the detected plume of gas.

11. The method of claim 10, wherein the gas density image comprises two or more gas density images, and the method comprises:
for each gas density image of the two or more gas density images, determining that the gas density image is indicative of a plume of gas or the gas density image is indicative of noise.

12. The method of claim 10, comprising determining an emission rate of the gas based on the gas density image.

13. A system for detecting a plume of gas in a gas density image, comprising:
an imaging device;
a methane gas sensor;
a display device;
a memory storage including a non-transitory, computer-readable medium comprising instructions; and
a hardware-based processor that executes the instructions to carry out stages comprising:
generating and training a machine learning model based on (1) raw spectroscopy data associated with the gas, one or more plumes of the gas, or both, (2) images generated based on the raw spectroscopy data associated with the gas, the one or more plumes of the gas, or both, or (3) both;
receiving a gas density image from an imaging device;
analyzing the gas density image using the machine learning model to detect a plume of gas; and
causing the display device to display an indication of the detected plume of gas.

14. The system of claim 13, wherein the gas density image comprises two or more gas density images, and for each gas density image of the two or more gas density images, the hardware-based processor executes instructions to determine that the gas density image is indicative of a plume of gas or the gas density image is indicative of noise.

15. The system of claim 13, wherein an emission rate of the gas based on the gas density image is determined.
